(19) United States
(12) Patent Application Publication
(10) Pub. No.: US 2013/0155263 A1
(43) Pub. Date: Jun. 20, 2013

(54) LENS CONTROL DEVICE AND CAMERA SYSTEM

(71) Applicant: Naotaka Kishida, Osaka (JP)

(72) Inventor: Naotaka Kishida, Osaka (JP)

(73) Assignee: PANASONIC CORPORATION, Osaka (JP)

(21) Appl. No.: 13/819,759

(22) PCT Filed: Dec. 27, 2010
(86) PCT No.: PCT/JP2010/007555

§ 371 Date: Feb. 28, 2013

(30) Foreign Application Priority Data
Sep. 1, 2010 (JP) 2010-195306

(51) Int. Cl. G02B 3/00; H04N 5/232

(52) U.S. Cl. CPC G02B 3/00; H04N 5/2328
USPC 348/208.5; 359/754

(57) ABSTRACT

The lens control device includes a wobbling controller that performs a wobbling operation for moving a predetermined drive lens minutely back and forth along the optical axis, an optical reduction controller that performs an optical canceling operation for moving a different drive lens minutely back and forth along the optical axis, to reduce change in magnification of a subject image which can be caused by the wobbling operation, the subject image being formed via the predetermined drive lens, and a controller that controls the optical reduction controller to perform the optical canceling operation for the change in magnification caused by the wobbling operation when a predetermined condition is not satisfied, and controls the optical reduction controller not to perform the optical canceling operation for the change in magnification caused by the wobbling operation when the predetermined condition is satisfied.

### TECHNICAL FIELD

The present invention relates to a lens control device and a camera system, and more particularly to a lens control device and a camera system that control a plurality of drive lenses.

### BACKGROUND ART

An autofocus control technique is known which locates a focus lens on a focus position of a subject image by moving the focus lens minutely back and forth (wobbling) along an optical axis. The focus lens has a zoom component. Hence, when the focus lens is subject to a wobbling operation, the magnification of a subject image slightly changes. To resolve such a problem, there is known a technique to keep change in magnification of a subject image caused by the wobbling operation, constant when a photographer adjusts an angle of view or the like while viewing a real-time captured image.

For example, an imaging apparatus of Patent Document 1 adjusts the position of a focus lens according to a wobbling operation, and changes imaging magnification according to a magnification control signal that cancels out a magnification of the focus lens with an electronic zoom change circuit. Thereby, change in magnification of a subject image caused by a wobbling operation is kept constant.

### PRIOR ART DOCUMENTS

### Patent Documents

Patent Document 1: Japanese Patent Application Laid-Open No. 11-136562

### SUMMARY OF INVENTION

### Problems to be Solved by the Invention

However, depending on a shooting situation, there may be a case in which a cancel operation for change in magnification caused by a wobbling operation does not need to always be performed, or a case in which it is better not to perform a cancel operation for change in magnification. Patent Document 1 does not take into account such circumstances. Thus, change in magnification caused by a wobbling operation cannot be cancelled out according to a shooting situation, resulting in inconvenience.

The present invention is made in view of the above-described problem, and is intended to provide a lens control device or camera system with excellent usability that can perform, according to a shooting situation, a cancel operation for change in magnification caused by a wobbling operation.

### Means for Solving the Problems

In a first aspect, there is provided a lens control device for controlling a plurality of drive lenses that can be driven independently of each other along an optical axis. The lens control device includes a wobbling controller that performs a wobbling operation for moving a predetermined drive lens of the plurality of drive lenses minutely back and forth along the optical axis, an optical reduction controller that performs an optical canceling operation for moving another drive lens different from the predetermined drive lens minutely back and forth along the optical axis, to reduce change in magnification of a subject image which can be caused by the wobbling operation, the subject image being formed via the predetermined drive lens, and a controller that controls the optical reduction controller to perform the optical canceling operation for the change in magnification caused by the wobbling operation when a predetermined condition is not satisfied, and controls the optical reduction controller not to perform the optical canceling operation for the change in magnification caused by the wobbling operation when the predetermined condition is satisfied.

In a second aspect, there is provided an interchangeable lens including a plurality of drive lenses that can be driven independently of each other along an optical axis and the above-described lens control device.

In a third aspect, there is provided an imaging apparatus including an imaging unit that captures a subject image formed via the predetermined drive lens to output image data and the above-described lens control device.

In a fourth aspect, there is provided a camera system including an interchangeable lens and a camera body to which the interchangeable lens is mountable. The interchangeable lens includes a plurality of drive lenses that can be driven independently of each other along an optical axis, a wobbling controller that performs a wobbling operation for moving a predetermined drive lens out of the plurality of drive lenses minutely back and forth along the optical axis, and an optical reduction controller that performs an optical canceling operation for moving another drive lens different from the predetermined drive lens minutely back and forth along the optical axis, to reduce change in magnification of a subject image which can be caused by the wobbling operation, the subject image being formed via the predetermined drive lens. The camera body includes a controller that controls the optical reduction controller to perform the optical canceling operation for the change in magnification caused by the wobbling operation when a predetermined condition is not satisfied, and controls the optical reduction controller not to perform the optical canceling operation for the change in magnification caused by the wobbling operation when the predetermined condition is satisfied.

### Effect of the Invention

According to the present invention, a lens control device or camera system is provided with excellent usability that can perform, according to a shooting situation, a cancel operation for change in magnification caused by a wobbling operation.

### BRIEF DESCRIPTION OF DRAWINGS

FIG. 1 is a diagram describing a schematic configuration of a digital camera;

FIGS. 2A to 2C are diagrams describing optical canceling operations performed in association with wobbling operations;

FIGS. 3A to 3C are diagrams describing a reduction in change in magnification by an optical canceling operation;

FIGS. 4A and 4B are diagrams describing change rates in magnification with respect to wobbling amplitudes;

FIG. 5 is a flowchart for determining whether to perform optical canceling according to wobbling amplitude;

FIGS. 6A and 6B are flowcharts for determining whether to perform optical canceling according to an operation for moving image recording; and

FIG. 7 is a flowchart for determining whether to perform optical canceling, based on silence priority during moving image recording.

### DESCRIPTION OF EMBODIMENTS

### 1. First Embodiment

The configuration and operation of a digital camera 1 according to a first embodiment will be described below using the drawings.

1-1. Configuration

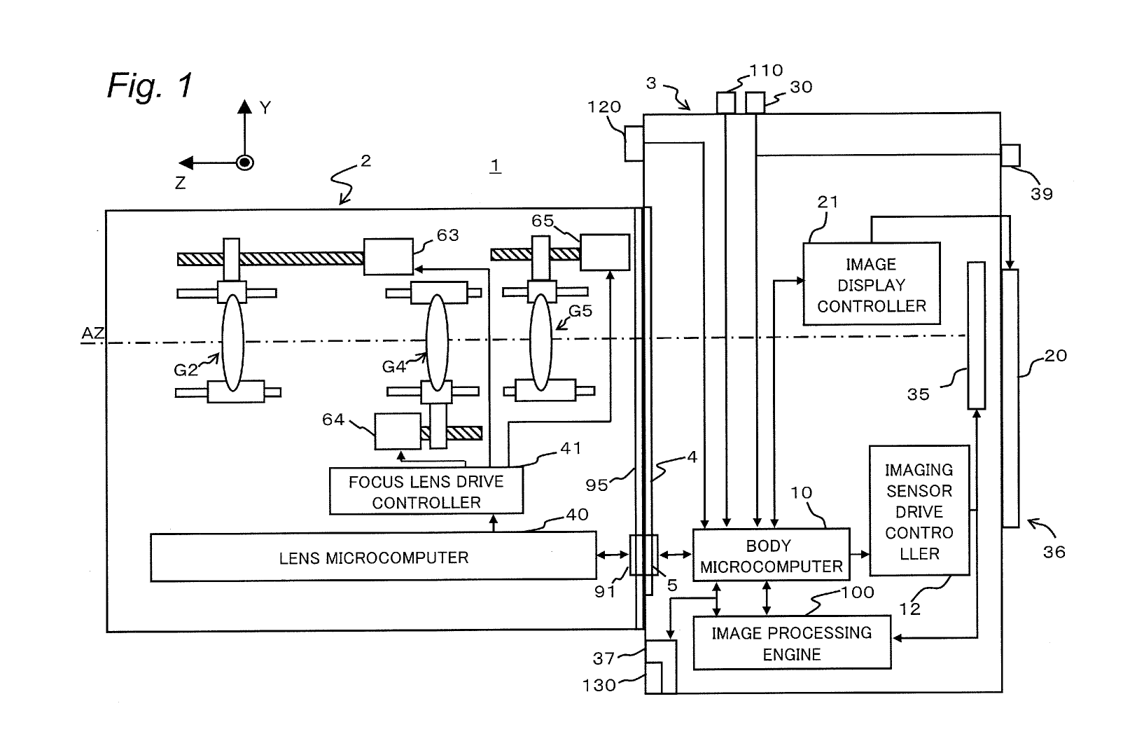

A configuration of the digital camera 1 will be described below. FIG. 1 is a diagram of a schematic configuration of the digital camera 1. The digital camera 1 (an example of an imaging apparatus) is an interchangeable lens-type digital camera, and includes a camera body 3 and an interchangeable lens 2 removably mounted to the camera body 3.

1-1-1. Configuration of Interchangeable Lens

A schematic configuration of the interchangeable lens 2 will be described. The interchangeable lens 2 is mounted to a body mount 4 provided at the front of the camera body 3, via a lens mount 95. Communication between a lens microcomputer 40 and a body microcomputer 10 is enabled by a lens-side communication unit 91 and a body-side communication unit 5. The interchangeable lens 2 includes an objective lens group G1 (not shown), a correction lens group G3 (not shown), and a plurality of focus lens groups G2, G4, and G5. By moving each of the focus lens groups G2, G4, and G5 along a direction of an optical axis, the shooting distance (object distance) is changed. The focus lens groups G2, G4, and G5 can be moved by focus motors 63, 64, and 65, respectively, and can be independently driven by a focus lens drive controller 41 according to instructions from the lens microcomputer 40. Independently and simultaneously driving the focus lens groups G2, G4, and G5 enables the speed of AF operation to increase. In addition, implementing such a three-axis focus configuration can reduce the overall length of the lens.

1-1-2. Configuration of Camera Body

A schematic configuration of the camera body 3 will be described. The camera body 3 includes the body mount 4 and the body-side communication unit 5 that performs communication with the interchangeable lens 2. In addition, the camera body 3 includes the body microcomputer 10, an image processing engine 100, an imaging sensor drive controller 12, an imaging sensor 35, an image display controller 21, a display unit 20, a card slot 37 to which a memory card 130 is mountable, a built-in microphone 120, a still image shooting operation button 30, a moving image shooting operation button 110, and a menu operation button 39.

The body-side communication unit 5 and the lens-side communication unit 91 can communicate data to each other. Communication data includes, for example, lens specific data (magnification change information), a control signal for focus drive, an exposure synchronizing signal, information indicating whether a moving image is being recorded, and information indicating whether silence priority is set. The body microcomputer 10 can generate various control signals by obtaining such communication data through the body-side communication unit 5 and the lens-side communication unit 91. For example, the body microcomputer 10 can generate a control signal for causing a focus lens to perform a wobbling operation, by obtaining magnification change information from the lens microcomputer 40.

The imaging sensor 35 is a sensor that converts an optical image formed via an optical system of the interchangeable lens 2 into an electrical signal to generate image data. The imaging sensor 35 is controlled with a timing signal generated by the imaging sensor drive controller 12. The image data generated by the imaging sensor 35 is supplied to the image processing engine 100 by which it is subject to various image processing.

The image processing engine 100 can perform various image processing on the image data supplied from the imaging sensor 35, such as a YC conversion process, a white balance correction process, a gamma correction process, an image enlargement/reduction process, an image compression/decompression process, and a focus determination process by detection of a contrast value. The image data processed by the image processing engine 100 is recorded in the memory card 130 or displayed on the image display unit 20 by the image display controller 21.

The image display unit 20 reproduces and displays a live monitor image, images recorded in the memory card, and so on based on a command from the image display controller 21.

The built-in microphone 120 converts sound into an electrical signal during moving image shooting. Though not shown in the drawing, an external microphone can also be connected to the digital camera 1. An external microphone has excellent directivity and is configured such that noise caused by the drivers of the interchangeable lens 2 or noise caused by the camera body 3 is less likely to be recorded. For that reason, when an external microphone is connected, the external microphone may be used while the built-in microphone 120 may not be used. During moving image shooting, the body microcomputer 10 performs a multiplexing process in a predetermined format type on moving image data captured by the imaging sensor 35 and audio data which is picked up and converted to digital format by the built-in microphone 120, and records the resulting data in the memory card 130 as a moving image file.

The memory card 130 stores still image data and moving image data generated by the imaging sensor 35. The body microcomputer 10 can perform a process of storing various data in the memory card 130 via the card slot 37.

On the top surface of the camera body 3, the still image shooting operating button (shutter button) 30 and the moving image shooting operation button 110 are provided. By operating the buttons, a corresponding shooting mode is performed. The still image shooting operation button 30 can take a half-press state in which the button is pressed lightly by a user, and a full-press state in which the button is pressed fully. When a half-press operation performed on the still image shooting operation button 30 by the user is received, the body microcomputer 10 performs autofocus control of focus lenses to focus on a subject. Then, when a full-press operation is received, still image data generated according to the timing of the pressing is recorded in the memory card 130. Further, when a full-press operation performed on the moving image shooting operation button 110 by the user is received, the body microcomputer 10 starts generation of audio data by the built-in microphone 120 and generation of moving image data for recording by the imaging sensor 35, and records a generated moving image file in the memory card 130. Namely, when an operation performed on the moving image shooting operation button 110 by the user is received, the body microcomputer 10 performs various operations for moving image recording.

The menu operation button 39 enables various camera setting operations by user operation.

The body microcomputer 10 is a control device that performs control of the main part of the camera body 3, and detects operations performed on the still image shooting operating button (shutter button) 30, the moving image shooting operating button 24, the menu operation button 39, and so on. In addition, the body microcomputer 10 has the function of detecting mounting of the interchangeable lens 2 to the camera body 3 or the function of obtaining information required for control of the digital camera 1 such as magnification change information, focal length information, and so on, from the interchangeable lens 2. Furthermore, the body microcomputer 10 sends control signals for controlling the focus lens groups G2, G4, and G5 to the lens microcomputer 40.

Note that, in the present embodiment, as an autofocus scheme, a contrast detection scheme using image data generated by the imaging sensor 35 is adopted. Using the contrast detection scheme can achieve a highly accurate focus adjustment.

Further, as a method for performing a focus adjustment all the time, there is wobbling drive. In wobbling drive, the body microcomputer 10 drives a focus lens to minutely move back and forth in the direction of optical axis to detect contrasts at both ends of the minute back and forth movement of the focus lens, and thereby determines a direction of focus position. In such a manner, the body microcomputer 10 checks a focus position and, when the focus position is displaced, the body microcomputer 10 drives the focus lens to the focus position. Wobbling is a focus scheme that is conventionally incorporated in video cameras or the like, and thus a detailed description thereof is omitted. In addition, in order to instantly enable still image shooting when receiving on the still image shooting operation button 30, a focus position is determined in advance by wobbling drive, and thereby a focus lens position is adjusted to be near the focus position. With this way, since the focus lens position is controlled to be near the focus position when still image shooting starts, the body microcomputer 10 does not need to perform a large readjustment of the focus lens position. Hence, still image shooting with little time-lag can be performed.

However, by performing wobbling drive in which a focus lens is driven to move minutely back and forth, moving image data generated by the imaging sensor 35 is affected by small change in magnification caused by the zoom component of the drive lens. That is, performing wobbling drive can yield a focus adjustment with little time-lag, but the influence of change in magnification caused by the wobbling drive causes a moving image to appear to be repeatedly reduced and enlarged slightly.

Hence, in the present embodiment, with respect to a lens on which wobbling drive is performed, another lens is driven to optically cancel out change in magnification which can be caused by the wobbling. In the present embodiment, the focus lens group G4 is used as a lens on which wobbling drive is performed, and the focus lens group G5 is used as a lens that optically cancels out the change in magnification. The focus lens group G4 and the focus lens group G5 respectively have the respective focus motors and thus can be driven independently of each other. Note that, in the following description, the focus lens group G4 is referred to as a “wobbling lens” and the focus lens group G5 is referred to as a “canceling lens”. In addition, the operation for optically canceling out change in magnification which can be caused by wobbling is referred to as “optical canceling”.

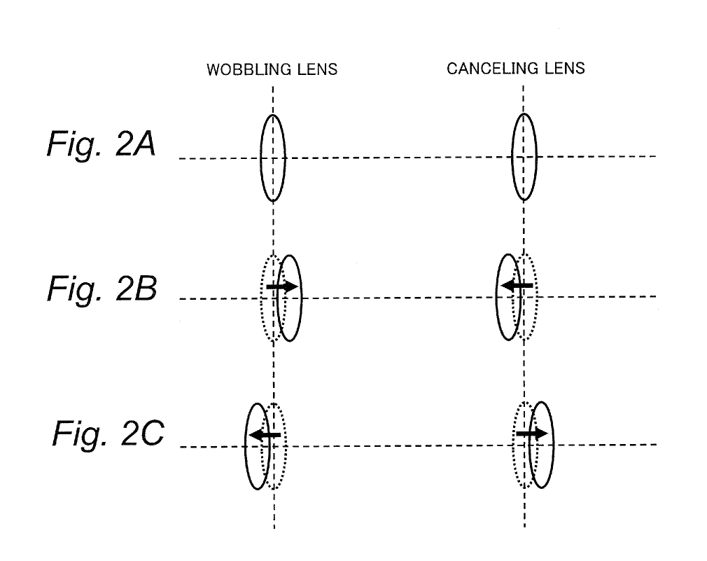

FIGS. 2A to 2C are image diagrams describing optical canceling operations performed in association with wobbling operations. When the wobbling lens and the canceling lens have refractive powers of the same polarity (positive or negative), the canceling lens is driven in the opposite direction to a direction in which the wobbling lens is driven minutely back and forth. Thereby, change in the magnification of an image shot can be made smaller. When the wobbling lens and the canceling lens have refractive powers of different polarities (positive or negative), the canceling lens is driven in the same direction as a direction in which the wobbling lens is driven to move minutely back and forth. Thereby, change in the magnification of an image shot can be made smaller. The following describes the case in which the wobbling lens and the canceling lens have refractive powers of the same polarity.

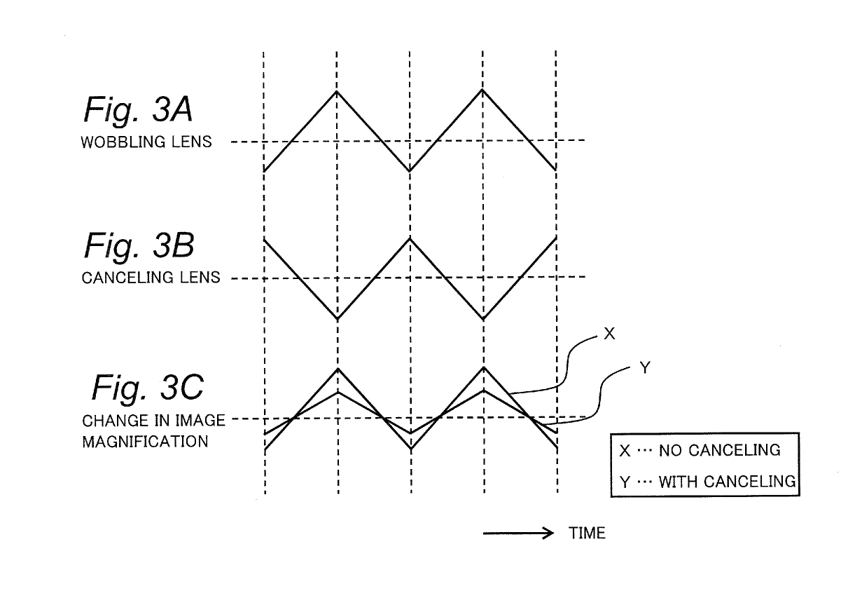

FIGS. 3A to 3C are diagrams describing a reduction in change in magnification by an optical canceling operation. In FIG. 3, since the wobbling lens and the canceling lens have refractive powers of the same polarity (positive or negative), the wobbling lens and the canceling lens are driven in opposite phases. As shown in FIGS. 3A to 3C, by performing optical canceling drive, change in magnification becomes smaller. Note that exposure is performed at timing of peaks and valleys.

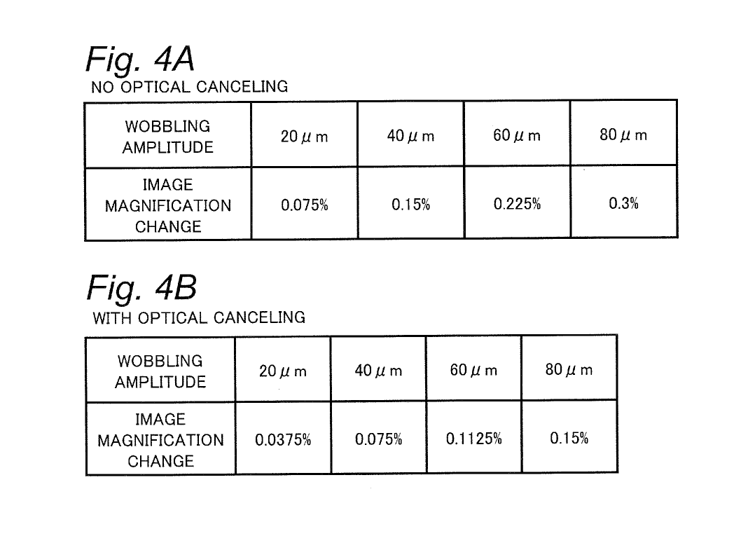

Using FIGS. 4A and 4B, change in magnification with respect to wobbling amplitude will be described. The wobbling amplitude is the amplitude of the lens obtained when the lens is driven back and forth along an optical axis in a wobbling operation. FIG. 4A is a diagram describing change rates in magnification with respect to wobbling amplitudes for the case of performing no optical canceling, and FIG. 4B is a diagram describing change rates in magnification with respect to wobbling amplitudes for the case of performing optical canceling. The wobbling amplitudes in the drawing each indicate a p-p (from a peak at one end to a peak at the other end) distance of wobbling. For example, when minute back and forth movement drive is performed at an image plane at a wobbling amplitude of 80 μm without performing optical canceling drive, as shown in FIG. 4A, the change in magnification is 0.3% at the maximum. On the other hand, performing optical canceling drive, as shown in FIG. 4B, enables the change in magnification to reduce to 0.15% at the maximum. When the change in magnification is 0.15% or less, although it depends on the focus speed, a resulting image has little awkwardness caused by frequent repetition of slight reduction and enlargement of an image. Thus, optical canceling of the present embodiment can yield an image with little awkwardness.

Further, information indicating the relationship between wobbling amplitude and change in magnification, such as that shown in FIGS. 4A and 4B (hereinafter, referred to as “magnification change information”) has different data for different interchangeable lenses according to the optical design. Hence, magnification change information is recorded in a ROM in the lens microcomputer 40 in the interchangeable lens 2. The magnification change information is sent to the body microcomputer 10 through the lens-side communication unit 91 and the body-side communication unit 4 when the interchangeable lens 2 is mounted to the camera body 3, and is then recognized by the body microcomputer 10. When optical canceling drive is not performed, the body microcomputer 10 sets wobbling amplitude based on magnification change information which is provided for the case of performing no optical canceling drive (information indicating the relationship in FIG. 4A). When optical canceling drive is performed, the body microcomputer 10 sets wobbling amplitude based on magnification change information which is provided for the case of performing optical canceling drive (information indicating the relationship in FIG. 4B). Thereby, the digital camera 1 can sets wobbling amplitude based on change in magnification according to execution/inexecution of an optical canceling operation. Namely, in a situation where change in magnification can be kept small by an optical canceling operation, control for increasing the wobbling amplitude can be performed.

1-1-3. Term correspondence

The lens group G2, the lens group G4, and the lens group G5 are examples of drive lenses. The lens group G4 is an example of a predetermined lens. The lens microcomputer 40 is an example of a wobbling controller. The lens group G5 is an example of a drive lens different from the predetermined lens. The lens microcomputer 40′is an example of an optical reduction controller. The lens microcomputer 40 is an example of a controller. The imaging sensor 35 is an example of an imaging unit. The image processing engine 100 is an example of an electronic reduction controller. The digital camera 1 is an example of a lens control device. The interchangeable lens 2 is an example of an interchangeable lens. The camera body 3 is an example of a camera body.

1-2. Operation

The operation of the digital camera 1 will be described below.

1-2-1 Determination as to Whether to Perform an Optical Canceling Operation

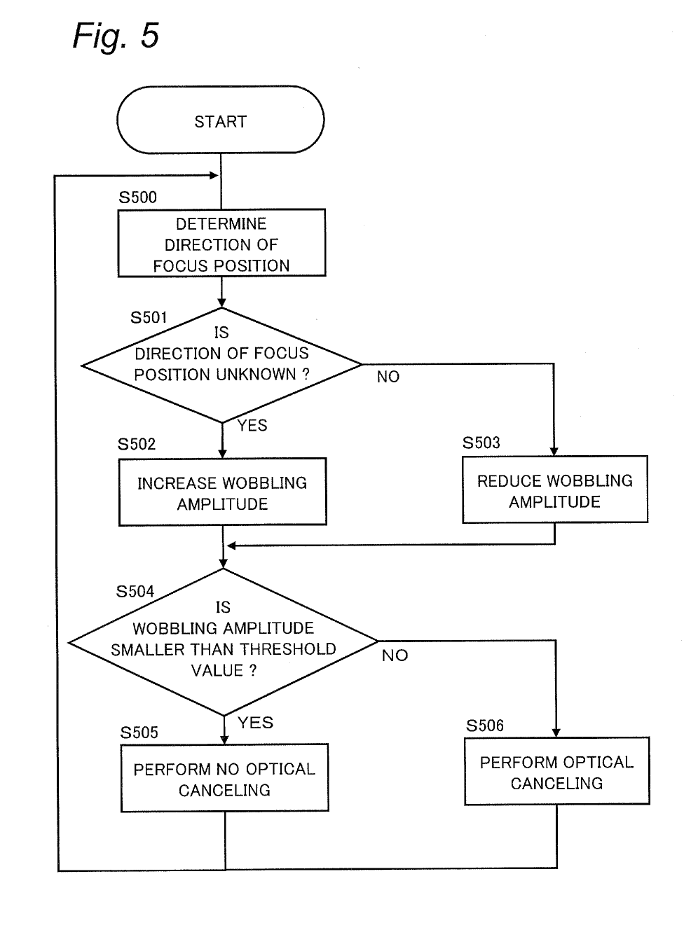

FIG. 5 is a flowchart showing a process of determining whether to perform an optical canceling operation. In an example of FIG. 5, the lens microcomputer 40 determines whether to perform optical canceling according to the wobbling amplitude.

First, the body microcomputer 10 drives the wobbling lens to minutely move back and forth in the direction of an optical axis to detect contrasts at both ends of the minute back and forth movement of the wobbling lens, and thereby determines a direction of a focus position (S500). When a direction of a focus position is unknown (YES at step S501), the body microcomputer 10 widens an area in which contrast detection is performed so that more accurate detection of a focus position can be performed. To do so, the body microcomputer 10 increases the wobbling amplitude (S502).

At that time, the body microcomputer 10 refers to information indicating the relationship between wobbling amplitude and change in magnification (information shown in FIGS. 4A and 4B), which is obtained from the interchangeable lens 2, and determines a value of the wobbling amplitude to be increased. Specifically, when the lens microcomputer 40 is not performing canceling drive, the body microcomputer 10 refers to magnification change information provided for the case of performing no optical canceling drive (information shown in FIG. 4A) and determines a wobbling amplitude so that change in magnification does not exceed a predetermined value. On the other hand, when the lens microcomputer 40 is performing canceling drive, the body microcomputer 10 refers to magnification change information provided for the case of performing optical canceling drive (information shown in FIG. 4B) and determines a wobbling amplitude so that change in magnification does not exceed the predetermined value. Note that the body microcomputer 10 periodically receives from the lens microcomputer information indicating whether the lens microcomputer 40 is performing the optical canceling drive.

As an example, the case will be considered in which the current wobbling amplitude is 40 μm and the predetermined value of change in magnification is 0.20%. In this case, when the lens microcomputer 40 is performing no optical canceling drive, the body microcomputer 10 refers to the magnification change information shown in FIG. 4A. According to an example shown in FIG. 4A, the wobbling amplitude next to 40 μm is 60 μm. The change in magnification with respect to the wobbling amplitude of 60 μm is 0.225% which exceeds a predetermined value of 0.20%. Hence, the body microcomputer 10 determines a wobbling amplitude which does not exceed the predetermined value of 0.20%. For example, linear interpolation based on the values shown in FIG. 4A can provide a wobbling amplitude of 53 μm at which the change in magnification is 0.20%. On the other hand, when the lens microcomputer 40 is performing cancel drive, the body microcomputer 10 refers to the magnification change information shown in FIG. 4B. At this time, the wobbling amplitude next to 40 μm is 60 μm and the change in magnification is 0.1125% which does not exceed the predetermined value (0.20%). Thus, the body microcomputer 10 increases the wobbling amplitude from 40 μm to 60 μm.

Then, the lens microcomputer 40 determines whether the set wobbling amplitude is larger than a threshold value (S504). The threshold value is determined based on change in magnification. Specifically, as the wobbling amplitude increases, change in magnification caused by a wobbling operation becomes larger. That is, when the wobbling amplitude is large, frequent repetition of slight enlargement and reduction of an image to be recorded becomes noticeable, degrading an appearance of the image. Hence, a reference value for change in magnification is determined and an amplitude value corresponding to the reference value is set as a threshold value. The lens microcomputer 40 determines whether the wobbling amplitude is larger than the threshold value.

For example, in the example of performing no optical canceling drive shown in FIG. 4A, when the reference value for change in magnification for wobbling amplitude is 0.15%, the threshold value for the wobbling amplitude is 40 μm.

When the wobbling amplitude is smaller than the threshold value, the lens microcomputer 40 does not perform optical canceling drive on the canceling lens (S505). On the contrary, when the wobbling amplitude is larger than the predetermined value, the lens microcomputer 40 performs optical canceling drive on the canceling lens (S506). Thereby, the change in magnification caused by the wobbling operation can be canceled out. Then, processing returns to step S500 to repeat each of the above-described steps.

On the other hand, in determination of a direction of a focus position, when a direction of a focus position can be recognized (NO at step S501), the body microcomputer 10 reduces the wobbling amplitude (S503). Then, those processes at and after the above-described step S504 are performed.

As described above, in the digital camera 1 according to the first embodiment, the lens microcomputer 40 is controlled not to perform the optical canceling operation for change in magnification caused by the wobbling operation when the amplitude (or the amount of movement) in a wobbling operation is smaller than a predetermined value. When the amplitude (or the amount of movement) in a wobbling operation is larger than the predetermined value, the lens microcomputer 40 is controlled to perform the optical canceling operation for change in magnification caused by the wobbling operation.

Further, optically canceling out change in magnification caused by a wobbling operation enables degradation in image quality to be prevented in comparison with the case of electronically canceling out (electronically zooming out and in an image).

1-2-3 Optical Canceling Operation According to Execution/Inexecution of Operation for Moving Image Recording

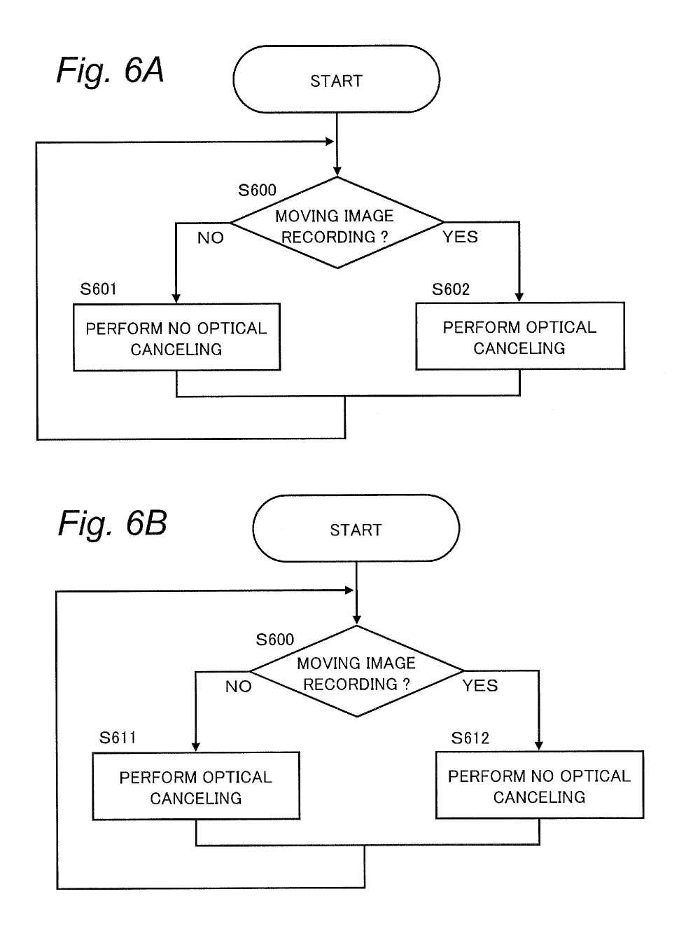

FIG. 6A is a flowchart for determining whether to perform optical canceling according to execution/inexecution of an operation for moving image recording. The lens microcomputer 40 determines whether to perform optical canceling according to execution/inexecution of a moving image recording operation. The process shown in FIG. 6A is, for example, inserted instead of step S506 in the flowchart shown in FIG. 5, and executed.

As described above, the body microcomputer 10 receives pressing of the moving image shooting operation button 110 by the user, and starts moving image recording. Afterward, when receiving again a pressing operation of the moving image shooting operation button 110 by the user, the body microcomputer 10 stops the moving image recording.

First, the lens microcomputer 40 determines whether moving image recording is being performed (S600). When moving image recording is not being performed (No at step S600), the lens microcomputer 40 does not perform optical canceling drive on the canceling lens (S601). On the other hand, when moving image recording is being performed (Yes at step S600), the lens microcomputer 40 performs optical canceling drive (S602). Then, the determination flow returns to step S600 to repeat the steps.

As described above, in the digital camera 1, the lens microcomputer 40 is controlled not to perform optical canceling operation for change in magnification caused by a wobbling operation when moving image recording is not being performed. When moving image recording is being performed, the lens microcomputer 40 is controlled to perform the optical canceling operation. Since change in magnification caused by a wobbling operation is likely to occur when moving image recording is being performed, an optical canceling operation enables a moving image with no awkwardness to be presented to the user. On the other hand, when moving image recording is not being performed, the influence of a wobbling operation on change in magnification is considered to be small, and thus, even when an optical canceling operation is stopped, there is no problem. In this embodiment, an optical canceling operation is performed only when needed, and thus it is effective in terms of power savings.

Note that, on the contrary to the process in FIG. 6A, as shown in a flowchart in FIG. 6B, when moving image recording is not being performed, an optical canceling operation may be performed (S611), and when moving image recording is being performed, an optical canceling operation may not be performed (S612). Driving of the canceling lens in an optical canceling operation may cause a drive sound. When the drive sound is loud, the drive sound is recorded as noise during moving image recording, which may not be preferred in some cases. A determination as to which one of the processes in FIGS. 6A and 6B is adopted may be appropriately made according to lens characteristics in view of preferred one of power savings and silencing.

1-2-4. Optical Canceling Operation based on Silence Priority

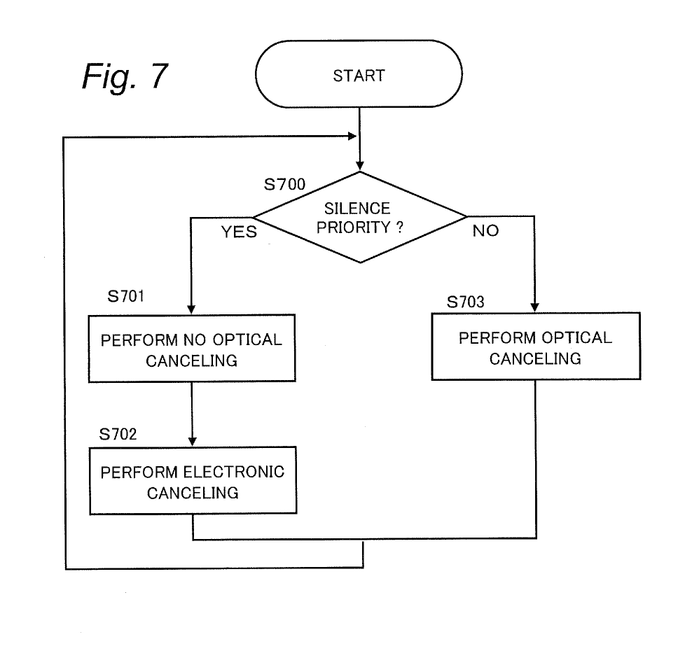

FIG. 7 is a flowchart for determining whether to perform optical canceling based on silence priority during moving image recording. The lens microcomputer 40 determines whether to perform optical canceling according to silence priority during moving image recording. The process in the flowchart in FIG. 7 is inserted instead of step S602 in the flowchart shown in FIG. 6A, and performed.

First, the lens microcomputer 40 determines whether silence priority is set (S700). Now, a determination as to silence priority will be described.

For example, when shooting is performed in a quiet environment, a drive sound generated during cancel drive of the interchangeable lens 2 is more noticeable than picked-up environmental sounds. Furthermore, when the environmental sounds are quiet, ACC (Auto Gain Control) of the microphone causes the recording sound level to be increase. Therefore, when it is determined that environmental condition is in a quiet state, it is preferable not to record a drive sound generated by a canceling operation. Hence, in such a case, the lens microcomputer 10 is set to silence priority. Specifically, when environmental sounds are picked up by the built-in microphone 120, and the body microcomputer 10 recognizes the picked-up environmental sounds and determines that the environmental sounds are in a quiet state, the body microcomputer 10 sends information indicating that the environmental sounds are in a quiet state to the lens microcomputer 40. In response to this, the lens microcomputer 40 is set to silence priority. Note that, when an external microphone is connected, a drive sound generated during cancel drive of the interchangeable lens 2 is less likely to be recoded, and thus, silence priority may be canceled. That is, when an external microphone is connected, the necessity to avoid a drive sound is low, and thus, cancel drive can be performed on the canceling lens. Therefore, when an external microphone is connected, priority can be given to a reduction in frequent repetition of slight enlargement and reduction.

Further, as another example of silence priority, there are some interchangeable lenses which generate a loud drive sound when a canceling lens is driven. In such a case, control may be performed to set silence priority to avoid generation of the drive sound. Specifically, when an interchangeable lens with a loud drive sound is mounted, a lens microcomputer 40 can be controlled to perform no optical canceling drive. Furthermore, the user can perform the setting to select silence priority and cancel silence priority by operating the menu operation button 39. In addition, by operating the menu operation button 39, the user can perform the setting regarding whether to record sound during moving image recording. When the setting is set not to record sound during moving image recording, silence priority may be canceled. At this time, sound is not recorded even during moving image recording, and thus there is no need to consider generation of a drive sound, and thus, the lens microcomputer 40 can perform cancel drive on the canceling lens. Hence, priority can be given to a reduction in frequent repetition of slight enlargement and reduction of an output image.

When silence priority is set (Yes at step S700), the lens microcomputer 40 does not perform optical canceling drive on the canceling lens (S701). At this time, in order to improve image quality as much as possible during moving image recording, electronic cancel is electronically performed by the image processing engine 100 (8702). The electronic cancel is a process for reducing change in magnification by electronically enlarging and reducing an image by the image processing engine 100 in the camera body 3. However, taking into account degradation in image quality caused by enlargement and reduction of an image by image processing, it is preferable to perform in advance an image trimming process. When silence priority is set, optical canceling is not driven in order to avoid generation of a drive sound, but electronic canceling in which no sound is generated enables a reduction in frequent repetition of slight enlargement and reduction of an output image to be performed.

Next, when silence priority is not set (No at step S700), the lens microcomputer 40 sets image quality priority. At this time, the lens microcomputer 40 drives the canceling lens to perform optical cancel (S703). Hence, priority can be given to a reduction in frequent repetition of slight enlargement and reduction of an output image. Then, the process flow returns to step S700 to repeat the above-described steps.

As described above, when priority is given to silent recording of moving image during moving image recording, the digital camera 1 can be controlled to perform no optical canceling operation in order to avoid generation of a lens drive sound. On the other hand, when higher priority is given to the image quality of a recorded image than to silence, the digital camera 1 can be controlled to perform an optical canceling operation in order to place importance on the appearance of an image to be recorded as a moving image. Note that the process in the flowchart in FIG. 7 may be inserted instead of step S505 in the flowchart shown in FIG. 5, and performed.

1-3. Conclusion

As described above, a digital camera 1 according to a first embodiment is the digital camera 1 including an interchangeable lens 2 and a camera body 3 to which the interchangeable lens 2 is mountable. The interchangeable lens 2 includes a plurality of lens groups G2, G4, and G5 that can be driven independently of each other along an optical axis, a lens microcomputer 40 that performs a wobbling operation for moving the predetermined lens group G4 out of the plurality of lens groups minutely back and forth along the optical axis, and the lens microcomputer 40 that performs an optical canceling operation for moving the lens group G5 different from the lens group G4 minutely back and forth along the optical axis, to reduce change in magnification of a subject image which can be caused by the wobbling operation, the subject image being formed via the lens group G4. Further, the camera body 3 includes the lens microcomputer 40 that performs control for performing of the optical canceling operation for the change in magnification caused by the wobbling operation when a predetermined condition (e.g., wobbling amplitude<threshold value) is not satisfied, and performs control for performing of no optical canceling operation for the change in magnification caused by the wobbling operation when the predetermined condition is satisfied.

The above-described configuration enables the digital camera 1 to perform a cancel operation for a wobbling operation according to a shooting situation.

In addition, in the digital camera 1 according to the first embodiment, when the amplitude or the amount of movement in a wobbling operation is smaller than a predetermined value, the lens microcomputer 40 controls the lens microcomputer 40 not to perform an optical canceling operation. When the amplitude of a wobbling operation is larger than the predetermined width, the lens microcomputer 40 controls the lens microcomputer 40 to perform the optical canceling operation. With this configuration, when the amplitude or the amount of movement in a wobbling operation is smaller than the predetermined width, change in magnification is allowable. Thus, importance is placed on avoidance of generation of a lens drive sound and the optical canceling operation can be controlled not to be performed. On the other hand, when the amplitude or the amount of movement in a wobbling operation is larger than the predetermined width, the change in magnification is noticeable. Thus, in order to place importance on the appearance of an image to be recorded as a moving image, the optical canceling operation can be controlled to be performed.

In addition, in the digital camera 1 according to the first embodiment, the lens microcomputer 40 controls whether to perform an optical canceling operation according to whether a moving image recording operation is being performed. For example, when moving image recording is not being performed, the lens microcomputer 40 does not perform the optical canceling operation, and when moving image recording is being performed, the lens microcomputer 40 controls the lens microcomputer 40 to perform the optical canceling operation. Thereby, when moving image recording is not being performed, the control can be performed not to execute an optical canceling operation with importance placed on power savings. When moving image is being recorded, in order to place importance on the appearance of an image to be recorded as a moving image, the control can be performed to execute the optical canceling operation.

In addition, when moving image recording is being performed and priority is given to silent recording of moving image, the body microcomputer 10 controls the lens microcomputer 40 not to perform an optical canceling operation. When moving image recording is being performed and priority is not given to silent recording of moving image, i.e., when priority is given to image quality, the body microcomputer 10 controls the lens microcomputer 40 to perform the optical canceling operation. When moving image recording is being performed and priority is given to silent recording of moving image, an optical canceling operation is not performed, whereby generation of a lens drive sound can be avoided. On the other hand, when moving image recording is being performed and priority is given to the image quality of a recorded image, an optical canceling operation is performed, whereby the appearance of the recorded image can be improved.

In addition, the body microcomputer 10 controls an image processing engine 100 to perform an electronic canceling operation for reducing change in magnification of a subject image caused by a wobbling operation, by minutely changing the range of area of an imaging sensor 35 to output image data generated by capturing a subject image formed via the lens group G4. When moving image recording is being performed and priority is given to silent recording of moving image, the body microcomputer 10 controls the image processing engine 100 to perform the electronic canceling operation.

In addition, in the digital camera 1 according to the above-described first embodiment, when an optical canceling operation is not being performed, the lens microcomputer 40 sets the amplitude or the amount of movement in a wobbling operation, based on first information regarding the change in magnification provided for a case of not performing the optical canceling operation. When an optical canceling operation is being performed, the lens microcomputer 40 sets the amplitude or the amount of movement in the wobbling operation, based on second information regarding the change in magnification provided for a case of performing the optical canceling operation. Thereby, the digital camera 1 can set a wobbling amplitude based on change in magnification according to whether or not the optical canceling operation is performed. Namely, in a situation where change in magnification can be kept small by an optical canceling operation, control for increasing of the wobbling amplitude can be performed.

### 2. Other Embodiments

An embodiment of the present invention is not limited to the above-described embodiment and various modifications and changes may be made thereto without departing from the spirit and scope of the present invention. Also, the above-described embodiment is essentially a preferred illustration and thus is not intended to limit the scope of the present invention, products to which the invention is applied, or usage of the invention.

Although the first embodiment exemplifies the lens microcomputer 40 as a controller, the present invention is not limited thereto. The functions of the controller may be implemented by the body microcomputer 10.

Although in the first embodiment a focus lens (G5) is used as a canceling lens, a zoom lens may be used as the canceling lens.

Although the first embodiment describes the case of determining whether to perform optical canceling drive according to whether moving image recording is being performed, the present invention is not limited thereto. For example, when real-time video captured by the imaging sensor 35 is outputted to an external display apparatus such as a television receiver, the screen of the television receiver is larger than the display unit 20 of the digital camera 1, and thus, frequent repetition of slight enlargement and reduction of an output image according to change in magnification is visually recognized prominently. Hence, when real-time video is outputted to a large screen (a screen size at which change in magnification is visually recognized prominently), even while moving image recording is not being performed, cancel drive may be performed on the canceling lens. Thereby, an image with an excellent appearance can also be provided to people watching real-time video on a large screen.

In addition, for users who feel uncomfortable with frequent repetition of slight enlargement and reduction of an output image according to change in magnification even with a small-size display unit such as the display unit disposed on the back surface of the digital camera 1, the optical cancel drive may be performed during a time other than the time in which moving image recording is being performed and real-time video is outputted to the display unit 20.

Although the above-described first embodiment describes the case of determining whether to perform an optical canceling operation according to whether the wobbling amplitude is larger than a predetermined width (threshold value), the present invention is not limited thereto. For example, when the central position of wobbling of the focus lens is shifted for adjusting a focus state, the amount of movement which is a total of the amount of shift and the wobbling amplitude may be compared with a predetermined width (threshold value), and a determination as to whether to perform an optical canceling operation may be made based on a result of the comparison result. Specifically, when the amount of movement in a wobbling operation is smaller than the predetermined width, an optical canceling operation for change in magnification caused by a wobbling operation may not be performed. When the amount of movement in a wobbling operation is greater than the predetermined width, an optical canceling operation may be performed to prevent the change in magnification caused by a wobbling operation. Thereby, even when the wobbling amplitude is smaller than the predetermined width, when the amount of movement which is a combined total of the wobbling amplitude and the amount of shift in the central position of wobbling is greater than the predetermined width, then frequent repetition of slight enlargement and reduction of an output image according change in magnification can be reduced.

Although the above-described embodiment describes the digital camera 1 including the interchangeable lens 2 and the camera body 3 to which the interchangeable lens 2 is mountable, the configuration of the apparatus is not limited thereto. Specifically, the idea of the first embodiment can be applied to a lens control device including a plurality of lens groups that can be driven to move independently of each other along an optical axis, a microcomputer which performs a wobbling operation for moving a predetermined lens group of the plurality of lens groups minutely back and forth along the optical axis, a microcomputer which performs an optical canceling operation for moving a lens group different from the predetermined lens group minutely back and forth along the optical axis, to reduce change in magnification of a subject image caused by the wobbling operation, the subject image being formed by the predetermined lens group, and a microcomputer which performs control not to perform the optical canceling operation for change in magnification caused by the wobbling operation in the case of a first condition and performs control to perform the optical canceling operation for change in magnification caused by the wobbling operation in the case of a second condition. Namely, the idea of the first embodiment can also be applied to any apparatus of an interchangeable lens and a camera with a built-in lens, as far as the apparatus has the above-described configuration.

### INDUSTRIAL APPLICABILITY

The applications of the present invention are not limited to digital cameras or interchangeable lenses, and the present invention can be applied to imaging apparatuses such as camcorders and mobile phones with cameras, and electronic devices capable of capturing an image through a lens.

### DESCRIPTION OF REFERENCE NUMERALS

1: DIGITAL CAMERA
2: INTERCHANGEABLE LENS
3: CAMERA BODY
4: BODY MOUNT
5: BODY-SIDE COMMUNICATION UNIT
10: BODY MICROCOMPUTER
12: IMAGING SENSOR DRIVE CONTROLLER
20: DISPLAY UNIT
21: IMAGE DISPLAY CONTROLLER
30: STILL IMAGE SHOOTING OPERATION BUTTON
35: IMAGING SENSOR (ONE EXAMPLE OF IMAGING DEVICE)
39: MENU OPERATION BUTTON
100: IMAGE PROCESSING ENGINE
110: MOVING IMAGE SHOOTING OPERATION BUTTON
120: BUILT-IN MICROPHONE
130: MEMORY CARD
40: LENS MICROCOMPUTER
41: FOCUS LENS DRIVE CONTROLLER
63: FIRST FOCUS MOTOR (ONE EXAMPLE OF FOCUS ACTUATOR)
64: SECOND FOCUS MOTOR (ONE EXAMPLE OF FOCUS ACTUATOR)
65: THIRD FOCUS MOTOR (ONE EXAMPLE OF FOCUS ACTUATOR)
91: LENS-SIDE COMMUNICATION UNIT
95: LENS MOUNT
G2: SECOND LENS GROUP
G4: FOURTH LENS GROUP
G5: FIFTH LENS GROUP

1. A lens control device for controlling a plurality of drive lenses that can be driven independently of each other along an optical axis, the lens control device comprising:
a wobbling controller that performs a wobbling operation for moving a predetermined drive lens of the plurality of drive lenses minutely back and forth along the optical axis;
an optical reduction controller that performs an optical canceling operation for moving another drive lens different from the predetermined drive lens minutely back and forth along the optical axis, to reduce change in magnification of a subject image which can be caused by the wobbling operation, the subject image being formed via the predetermined drive lens; and
a controller that controls the optical reduction controller to switch between executing and not executing the optical canceling operation for the change in magnification caused by the wobbling operation according to whether a predetermined condition is net satisfied.

2. The lens control device according to claim 1, wherein the controller controls the optical reduction controller not to execute the optical canceling operation when an amount of movement of the predetermined drive lens in the wobbling operation is smaller than a predetermined value, and controls the optical reduction controller to execute the optical canceling operation when the amount of movement is greater than the predetermined value.

3. The lens control device according to claim 1, wherein the controller controls execution of the optical canceling operation, according to whether a moving image recording operation is being performed.

4. The lens control device according to claim 1, wherein the controller controls the optical reduction controller not to execute the optical canceling operation when moving image recording is being performed and priority is given to silent recording of moving image, and controls the optical reduction controller to execute the optical canceling operation when moving image recording is not being performed and priority is not given to silent recording of moving image.

5. The lens control device according to claim 4, further comprising
an electronic reduction controller that performs an electronic canceling operation for reducing the change in magnification of the subject image caused by the wobbling operation, by changing a range of area of an imaging unit to output image data generated by capturing a subject image formed via the predetermined drive lens, wherein
the controller controls the electronic reduction controller to perform the electronic canceling operation when priority is given to silent recording of moving image during the recording of moving image.

6. The lens control device according to claim 1, wherein
when the optical canceling operation is not being executed, the wobbling controller sets an amount of movement of the predetermined drive lens in a wobbling operation, based on first information regarding the change in magnification provided for a case of not performing the optical canceling operation, and
when the optical canceling operation is being executed, the wobbling controller sets the amount of movement, based on second information regarding the change in magnification provided for a case of performing the optical canceling operation.

7. An interchangeable lens comprising:
a plurality of drive lenses that can be driven independently of each other along an optical axis; and
the lens control device according to claim 1.

8. An imaging apparatus comprising:
an imaging unit that captures a subject image formed via the predetermined drive lens to output image data; and
the lens control device according to claim 1.

9. A camera system including an interchangeable lens and a camera body to which the interchangeable lens is mountable, wherein
the interchangeable lens comprises:
a plurality of drive lenses that can be driven independently of each other along an optical axis;
a wobbling controller that performs a wobbling operation for moving a predetermined drive lens of the plurality of drive lenses minutely back and forth along the optical axis; and
an optical reduction controller that performs an optical canceling operation for moving another drive lens different from the predetermined drive lens minutely back and forth along the optical axis, to reduce change in magnification of a subject image which can be caused by the wobbling operation, the subject image being formed via the predetermined drive lens, and
the camera body comprises
a controller that controls the optical reduction controller to switch between executing and not executing the optical canceling operation for the change in magnification caused by the wobbling operation according to whether a predetermined condition is satisfied.

10. The camera system according to claim 9, wherein the controller controls the optical reduction controller not to execute the optical canceling operation when an amount of movement of the predetermined drive lens in wobbling operation is smaller than a predetermined value, and controls the optical reduction controller to execute the optical canceling operation when the amount of movement is greater than the predetermined value.

11. The camera system according to claim 9, wherein the controller controls execution of the optical canceling operation, according to whether a moving image recording operation is being performed.

12. The camera system according to claim 9, wherein the controller controls the optical reduction controller not to execute the optical canceling operation when moving image recording is being performed and priority is given to silent recording of moving image, and controls the optical reduction controller to execute the optical canceling operation when moving image recording is not being performed and priority is not given to silent recording silence.

13. The camera system according to claim 12, further comprising
an electronic reduction controller that performs an electronic canceling operation for reducing the change in magnification of the subject image caused by the wobbling operation, by changing a range of area of an imaging unit to output image data generated by capturing a subject image formed via the predetermined drive lens, wherein
the controller controls the electronic reduction controller to perform the electronic canceling operation when moving image recording is being performed and priority is given to silent recording of moving image.

14. The camera system according to claim 9, wherein
when the optical canceling operation is not being executed, the wobbling controller sets an amount of movement of the predetermined drive lens in the wobbling operation, based on first information regarding the change in magnification provided for a case of not performing the optical canceling operation, and
when the optical canceling operation is being performed, the wobbling controller sets the amount of movement, based on second information regarding the change in magnification provided for a case of performing the optical canceling operation.
